(19) United States
(12) Patent Application Publication
(10) Pub. No.: US 2022/0019838 A1
(43) Pub. Date: Jan. 20, 2022

(54) Image Processing Method and Device, and Storage Medium

(71) Applicant: Shenzhen Sensetime Technology Co., Ltd., Shenzhen (CN)

(72) Inventors: Haoxuan Dou, Shenzhen (CN); Jing Xu, Shenzhen (CN); Guanliang Li, Shenzhen (CN); Yufei Yang, Shenzhen (CN); Minmiao Li, Shenzhen (CN)

(73) Assignee: Shenzhen Sensetime Technology Co., Ltd., Shenzhen (CN)

(21) Appl. No.: 17/488,634

(22) Filed: Sep. 29, 2021

Related U.S. Application Data
(63) Continuation of application No. PCT/CN2020/092391, filed on May 26, 2020.

(30) Foreign Application Priority Data
Aug. 22, 2019 (CN) 201910779555.3

(51) Int. Cl. G06K 9/46; G06K 9/62

(52) U.S. Cl. CPC G06K 9/46; G06K 9/627; G06K 9/6218

(57) ABSTRACT

The present disclosure relates to an image processing method and apparatus, an electronic device and a storage medium. The method comprises: extracting features from a to-be-processed image to so as to obtain a first feature of the image; determining the image category of the image according to the first feature and category center features of multiple reference image categories in a feature library; and in a case where the image category of the image is the first category of the multiple reference image categories, updating the category center feature of the first category according to the first feature and multiple pieces of feature information of the first category in the feature library. The method may improve the speed and accuracy of image retrieval.

### CROSS-REFERENCE TO RELATED APPLICATION

This application a continuation of and claims the priority under 35 U.S.C. 120 to PCT Application No. PCT/CN2020/092391, filed on May 26, 2020, which claims the priority to Chinese Patent Application No. 201910779555.3 filed with China National Intellectual Property Administration, on Aug. 22, 2019, entitled “Image Processing Method and Apparatus, Electronic Device and Storage Medium”. All the above referenced priority documents are incorporated herein by reference in their entireties.

### TECHNICAL FIELD

The present disclosure relates to the technical field of computers, and particularly to an image processing method and apparatus, an electronic device and a storage medium.

### BACKGROUND

With the development of relevant technologies, face searching has been widely used, especially when tracking down a criminal in the public security industry, it is necessary to search an image of an unidentified suspect in a massive image database. A commonly used face searching method is to compare an image to be searched with images in the database one by one.

### SUMMARY

The present disclosure provides an image processing technical solution.

According to an aspect of the present disclosure, there is provided an image processing method, which includes: performing feature extraction on a to-be-processed image to obtain a first feature of the to-be-processed image; determining an image category of the to-be-processed image according to the first feature and category center features of a plurality of reference image categories in a feature library; and in response to the image category of the to-be-processed image being a first category among the plurality of reference image categories, updating the category center feature of the first category according to the first feature and a plurality of pieces of feature information of the first category in the feature library.

According to an aspect of the present disclosure, there is provided an image processing device, which includes a processor and a memory configured to store processor executable instructions, wherein the processor is configured to execute instructions stored in the memory to execute the above image processing method.

According to an aspect of the present disclosure, there is provided a non-transitory computer readable storage medium having computer program instructions stored thereon, wherein when the computer program instructions are executed by a processor, the processor is caused to perform the above image processing method.

In the present embodiment, the image category of the to-be-processed image can be determined according to the first features of the image and the category center features of the reference image categories; when the to-be-processed image belongs to the existing first category, the category center features of the first category are updated according to the first features and the plurality of pieces of feature information of the first category to realize the clustering on the to-be-processed image, so that the clustering is performed prior to the searching during the image searching.

It should be understood that the above general descriptions and the following detailed descriptions are only exemplary and illustrative, and do not limit the present disclosure.

Other features and aspects of the present disclosure will become apparent from the following detailed descriptions of exemplary embodiments with reference to the accompanying drawings.

### BRIEF DESCRIPTION OF THE DRAWINGS

The drawings described here are incorporated into the specification and constitute a part of the specification. The drawings illustrate embodiments in conformity with the present disclosure and are used to explain the technical solutions of the present disclosure together with the specification.

FIG. 1 illustrates a flow chart of an image processing method according to an embodiment of the present disclosure.

FIG. 2 illustrates a schematic diagram of an application scenario of the image processing method according to an embodiment of the present disclosure.

FIG. 3 illustrates a block diagram of an image processing apparatus according to an embodiment of the present disclosure.

FIG. 4 illustrates a block diagram of an electronic device according to an embodiment of the present disclosure.

FIG. 5 illustrates a block diagram of an electronic device according to an embodiment of the present disclosure.

### DETAILED DESCRIPTION

Various exemplary embodiments, features and aspects of the present disclosure are described in detail below with reference to the accompanying drawings. Reference numerals in the drawings refer to elements with same or similar functions. Although various aspects of the embodiments are illustrated in the drawings, the drawings are unnecessary to draw to scale unless otherwise specified.

The term “exemplary” herein means “using as an example and an embodiment or being illustrative”. Any embodiment described herein as “exemplary” should not be construed as being superior or better than other embodiments.

The term “and/or” used herein is only an association relationship describing the associated objects, which means that there may be three relationships, for example, A and/or B may mean three situations: A exists alone, both A and B exist, and B exists alone. Furthermore, the term “at least one of” herein means any one of a plurality of or any combinations of at least two of a plurality of, for example, “including at least one of A, B and C” may represent including any one or more elements selected from a set consisting of A, B and C.

Furthermore, for better describing the present disclosure, numerous specific details are illustrated in the following detailed description. Those skilled in the art should understand that the present disclosure may be implemented without certain specific details. In some examples, methods, means, elements and circuits that are well known to those skilled in the art are not described in detail in order to highlight the main idea of the present disclosure.

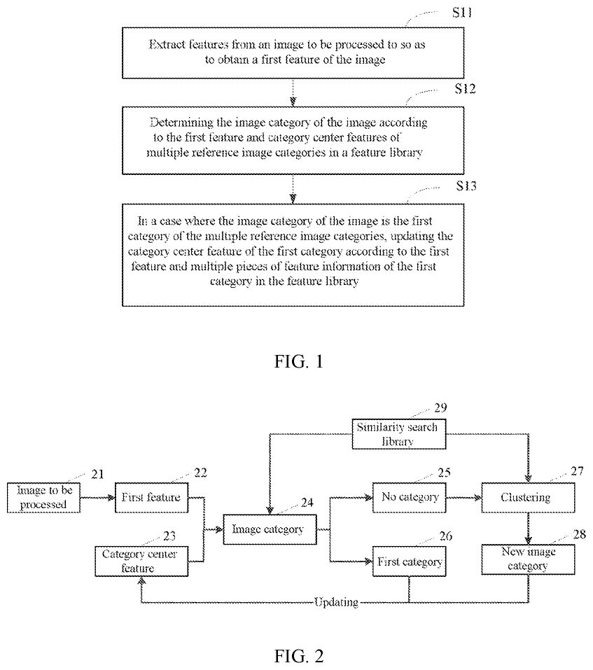

FIG. 1 illustrates a flow chart of an image processing method according to an embodiment of the present disclosure. As shown in FIG. 1, the image processing method includes the following steps S11-S13:

Step S11: performing feature extraction on a to-be-processed image to obtain a first feature of the image;

Step S12: determining an image category of the to-be-processed image according to the first features and category center features of a plurality of reference image categories in a feature library; and

Step S13: in response to the image category of the to-be-processed image being a first category among the plurality of reference image categories, updating the category center feature of a first category according to the first feature and a plurality of pieces of feature information of the first category in the feature library.

According to the embodiment of the present disclosure, the image category of the to-be-processed image can be determined according to the first feature of the image and the category center features of the reference image categories; when the to-be-processed image belongs to the existing first category, the category center feature of the first category is updated according to the first feature and the plurality of pieces of feature information of the first category to realize the clustering on the to-be-processed image, so that clustering is performed prior to searching during the image searching, to improve the image searching accuracy and the recall rate; by comparing the to-be-processed image with the category center features, the number of image comparisons during searching may be reduced, so that the image searching speed is increased; and at the same time, the features of the to-be-processed image may be added to the feature library, so that the number of images and features corresponding to each category may be increased, thereby further improving the searching accuracy.

In a possible implementation, the image processing method may be executed by an electronic device such as a terminal device or a server. The terminal device may be user equipment (UE), a mobile device, a user terminal, a terminal, a cellular phone, or a cordless telephone, a personal digital assistant (PDA), a handheld device, a computing device, a vehicle-mounted device, a wearable device, etc. The method may be implemented by a processor executing a computer readable instruction stored in a memory. Alternatively, the method may be executed by the server.

In a possible implementation, the to-be-processed image may include one or more pictures or video frames, wherein the pictures or video frames include faces. A plurality of to-be-processed images may be classified into one or more clusters according to factors such as face, time, place and the like, wherein the cluster is primary classification for the to-be-processed image. One cluster may contain one or more to-be-processed images. For example, image acquisition is carried out for a same person for multiple times at different time. The pictures of the same person may be classified into multiple clusters according to different acquisition time.

In a possible implementation, the image processing method may be used to process the to-be-processed image in real time or periodically. For example, the image processing may be carried out once a day or once a week; or the image processing may be started after a certain number of to-be-processed images may have been acquired; or the image processing may be carried out prior to the image searching. The present disclosure does not limit the start time of the image processing.

In a possible implementation, feature extraction may be performed on the to-be-processed image to obtain the first feature of the image in the step S11. The first feature may include one or more pieces of feature information of the to-be-processed image, for example, the first feature may include multiple pieces of feature information of the face. When the to-be-processed image involves multiple pictures, the first feature may include multiple pieces of feature information of multiple pictures. After the feature extraction is performed on the to-be-processed image, the extracted feature information may be used as the first feature of the to-be-processed image. The present disclosure does not limit the way of feature extraction.

In a possible implementation, the step S11 may include: performing feature extraction on the to-be-processed image to obtain second features of the image; and normalizing the second features to obtain the first feature of the to-be-processed image. The normalization may generalize and unify the feature information, so that the feature values are unified within a certain range. The normalization may, for example, include regularization. The present disclosure does not limit a specific way of normalization.

The second features of the to-be-processed image are normalized, and the normalized feature values are used as the first feature of the to-be-processed image, so that the feature values of the first features are all within a certain range, thereby reducing the calculation complexity, and increasing the calculation efficiency.

In a possible implementation, after the first feature of the to-be-processed image are obtained, an image category of the to-be-processed image may be determined according to the first feature and category center features of a plurality of reference image categories in the feature library in the step S12.

The reference image categories may be classified image categories in the feature library. One image category may be a set of images of a certain type, for example, an image set of a same person.

For each reference image category, the category center feature thereof may be determined. The category center features of the reference image categories may be determined by using a way of category center determination of various clustering algorithms (such as k-means algorithms, mean shift algorithms, hierarchical clustering algorithms, etc.). As clustering algorithms are different, corresponding ways of calculating the category center features are different too. Those skilled in the art may determine the way of determining the category center features according to the actuation situation, which is not limited in the present disclosure.

After the category center features of the plurality of reference image categories are determined, the image category of the to-be-processed image may be determined according to the first features and category center features of a plurality of reference image categories in a feature library. That is, the image category of the to-be-processed image may be determined by comparing the first features of the image with the category center features of the plurality of reference image categories. For example, when the k-means algorithm is used, a distance from each of the first features of the to-be-processed image to each of the category center features of the plurality of reference image categories may be calculated respectively, and the image category of the to-be-processed image is determined according to the distance.

In a possible implementation, prior to the step S12, the method may further include: performing category center extraction on the feature information of each of the plurality of reference image categories in the feature library respectively to obtain the category center feature of the reference image category. That is to say, for each of the plurality of reference image category in the feature library, the category center extraction may be performed respectively on the feature information. The extracted feature information may be used as the category center feature of the reference image category. The way of extracting category center may be determined according to the clustering algorithm. For example, when the k-means algorithm is used to perform the category center extraction, the feature information of the image of each of the reference image categories may be determined first, the distance (such as an Euclidean distances) among each of the feature information may be calculated, then a mean value of each of the distances is determined, and the feature information corresponding to the mean value is determined as the category center features of the reference image categories. The present disclosure does not limit the way of extracting category center.

In the present embodiment, the category center extraction is performed on the feature information of each of the plurality of reference image categories to obtain the category center feature of the reference image category, so that the accuracy of the category center feature may be increased.

In a possible implementation, the step S12 may include: acquiring a plurality of first distances between the first feature and each of a plurality of category center features; and in response to a second distance as a minimum distance value among the plurality of first distances being less than or equal to a distance threshold, determining the image category of the to-be-processed image as the first category corresponding to the second distance. The distance threshold may be preset. The present disclosure does not limit a specific value of the distance threshold.

In a possible implementation, a distance between the first feature of the to-be-processed image and each of a plurality of category center features may be calculated separately, thus obtaining a plurality of first distances. Among the plurality of first distances, the first distance as a minimum distance value is used as the second distance. Then a relationship between the second distance and the preset distance threshold is judged. If the second distance is less than or equal to the distance threshold, the image category of the to-be-processed image may be determined as the first category corresponding to the second distance.

In the present embodiment, the image category of the to-be-processed image is determined according to the relationship between the second distance and the distance threshold, and the image category of the to-be-processed image is determined as the first category corresponding to a second distance when the second distance is less than or equal to the distance threshold, which is simple and rapid, so that the image classification efficiency and accuracy can be increased.

In a possible implementation, the category center features include N category center features, where N is a positive integer. Acquiring the plurality of first distances between the first feature and the plurality of category center features includes: performing quantification on the N category center features respectively to obtain N feature vectors; acquiring N third distances between the first feature and the N feature vectors respectively; determining K category center features corresponding to K minimum third distances among the N third distances; and determining K first distances between the first feature and the K category center features, where K is a positive integer, and K<N.

In a possible implementation, the quantification may be performed respectively on the N category center features to obtain N feature vectors. For example, an IVFADC algorithm in Facebook AI Similarity Search (Faiss) which is an open-source similarity search library provided by Facebook may be used to perform quantification on the N category center features. The IVFADC algorithm includes a rough quantizer (such as a k-means algorithm) and a multiplication quantizer. Firstly, the rough quantizer (such as the k-means algorithm) may be used to perform rough quantification on the N category center features. The N category center features are classified into P groups (P is a positive integer, and P<N), and a quantification center of each group and a residual vector between each vector in the group and the quantification center are calculated respectively. Then the multiplication quantizer is used to perform multiplication quantification on each residual vector. The D-dimensional residual vectors are divided into M (D and M both are positive integers, and M<D) subvectors along the dimension, and the rough quantification is performed on each subvector, so that the D-dimensional residual vectors are compressed to M dimensions, thereby obtaining N M-dimensional feature vectors corresponding to the N category center features.

In a possible implementation, N third distances between the first feature and the N feature vectors may be acquired respectively. For example, the N third distances between the first feature and the N feature vectors may be calculated by using an asymmetric distance. The third distances are approximate distances (such as approximate Euclidean distances).

In a possible implementation, the third distances may be calculated by using formula (1) below:

$${‖ x - q ( y ) ‖}_{2}^{2} = {‖ x - {q}_{1} ( y ) - {q}_{2} ( y - {q}_{1} ( y ) ) ‖}_{2}^{2} = {‖ {q}_{2} ( y - {q}_{1} ( y ) ) ‖}_{2}^{2} + 2 〈 {q}_{1} ( y ) , {q}_{2} ( y - {q}_{1} ( y ) ) 〉 + {‖ x - {q}_{1} ( y ) ‖}_{2}^{2} - 2 〈 x , {q}_{2} ( y - {q}_{1} ( y ) ) 〉 \qquad ( 1 )$$

In the formula (1), x represent a first feature; y represents a category center feature; q represents quantification; q₁ represents a rough quantizer; q₁(y) represents a quantification result (a quantification center) of the rough quantizer; q₂ represents a multiplication quantizer; q₂ (y−q₁(y)) represents a multiplication quantification result, whose input y−q₁(y) represents a residual between y and the quantification center.

In a possible implementation, k smallest third distances may be selected from N third distances, and K category center features corresponding to the K third distances may be determined. For the K category center features, a precise distance (such as an inner product distance) between the first feature and each category center feature may be calculated respectively and used as K first distances between the first feature and the K category center features.

Quantification and dimension reduction are performed on the N category center features. When K category center features among the N category center features are used to calculate the first distances, the amount of operations may be reduced, so that the calculation efficiency of the plurality of first distances may be increased.

In a possible implementation, the step S12 may include: in response to the second distance being greater than the distance threshold, determining the image category of the to-be-processed image to be not any category of the plurality of reference image categories. That is to say, in a case where the second distance is greater than the distance threshold, it can be considered that the to-be-processed image does not belong to any one of the plurality of reference image categories in the feature library, and a new image category needs to be determined for the to-be-processed image, so that the image classification accuracy may be increased.

In a possible implementation, the category center features of the first category may be updated according to the first feature and a plurality of pieces of feature information of the first category in the feature library in response to the image category of the to-be-processed image being a first category among the plurality of reference image categories in the step S13. For example, when the k-means algorithm is used to update the category center feature of the first category, the first feature may be added to the first category as new feature information. The distances among various feature information in the first category are calculated respectively to determining the mean value of each of the distances. The feature information corresponding to the mean value is used to update the category center feature of the first category. Other clustering algorithms may also be used to update the category center feature of the first category, which is not limited in the present disclosure. In this way, the category center features of the reference image categories in the feature library may be updated when new images are added.

In a possible implementation, the method may further include: in response to the image category of the to-be-processed image being not any category of the plurality of reference image categories, performing category center extraction on the first feature of the to-be-processed image to obtain a category center feature of a second category of the image; and adding the category center feature of the second category and the first feature to the feature library, and adding the second category to the plurality of reference image categories.

In a possible implementation, in a case where the to-be-processed image is a picture, and the image category of the to-be-processed image is not any category of the plurality of reference image categories, the to-be-processed images that do not belong to the any category may be clustered to a new category, i.e., a second category. In this circumstance, the category center extraction may be performed on the first feature of the to-be-processed image to obtain the category center feature of the second category. The extraction of category center is similar to the above, and is not repeated here.

In a possible implementation, after the category center feature of the second category is determined, the first feature and the category center feature of the second category may be added to the feature library, and the second category may be added to the plurality of reference image category, so that the new feature information and image category may be updated into the feature library in time.

In the present embodiment, when the image category matching fails, a new image category is established for the to-be-processed image according to the first feature, which may enable the feature information and the image category in the feature library to be updated as the new images increase, so that the feature information and image categories in the feature library may be enriched continuously, thereby further improving the image searching accuracy.

In a possible implementation, the method may further include: in response to the image category of the to-be-processed image being not any category of the plurality of reference image categories, performing clustering on the first feature of the to-be-processed image to obtain one or more third categories; performing category center extraction on the one or more third categories to obtain a category center feature of the one or more third categories; and adding the category center feature of the one or more third categories and the first feature to the feature library, and adding the third category to the plurality of reference image categories.

For example, in a case where the to-be-processed image may be multiple pictures and the image category of the to-be-processed image is not any category of the plurality of reference image categories, the first features of the to-be-processed image may be clustered to obtain one or more third categories. When the to-be-processed image may be multiple pictures of a same object, one third category may be obtained after the clustering; and when the to-be-processed image may be multiple pictures of multiple objects, a plurality of third categories may be obtained after the clustering.

For example, according to the first feature of a to-be-processed image, the searching may be carried out among a plurality of other to-be-processed images (for example, searched by Faiss) to obtain the first K similarity results; for the K similarity results, connected components may be found by drawing an affinity diagram to determine the clustering, or the clustering may be determined by DFS (Deep First Search) recursive coloring. Whether to perform the coloring may be determined according to a similarity threshold. For example, if the similarity threshold is 0.7, the similarity result greater than the similarity threshold may be colored, and the similarity result less than the similarity threshold may be skipped. It should be understood that other clustering algorithms may also be used to perform clustering on the to-be-processed image, which is not limited in the present disclosure.

In a possible implementation, after the to-be-processed image is clustered to obtain one or more third categories, the category center extraction may be performed respectively on the one or more third categories to obtain the category center feature of the one or more third category; and the first feature of the to-be-processed image and the category center features of the one or more third categories may be added to the feature library, and the one or more third categories may be added to the plurality of reference image categories, so that the new feature information and image categories may be updated into the feature library in time. The category center extraction is similar to the above, and is not repeated here.

In the present embodiment, when the to-be-processed image may be multiple pictures, the to-be-processed image can be clustered to obtain one or more new image categories when the image category matching fails, and the new image categories and the category center features are added to the feature library, which may enable the feature information and image categories in the feature library to be updated as new images are added, so that the feature information and image categories in the feature library may be enriched continuously, thereby improving the image searching accuracy.

In a possible implementation, the method further includes: in response to a plurality of fourth categories in the feature library corresponding to a same object, performing re-clustering on the feature information of the plurality of fourth categories to obtain a fifth category; performing category center extraction on the fifth category to obtain a category center feature of the fifth category; and adding the category center feature of the fifth category to the feature library, and adding the fifth category to the plurality of reference image categories.

The plurality of fourth categories corresponding to the same object may refer to that the same object (such as the same face) has a plurality of image categories in the feature library, i.e., the fourth categories. In this circumstance, the feature information of the plurality of fourth categories may be re-clustered to obtain the fifth category, that is, the plurality of image categories of the same object are re-clustered and merged into one image category.

After the fifth category is obtained, the category center extraction may be performed on the fifth category to obtain the category center feature of the fifth category. The category center feature of the fifth category is added to the feature library, and the fifth category is added to the plurality of reference image categories.

In the present embodiment, a plurality of image categories of the same object in the feature library are re-clustered and merged so as to increase the image classification accuracy, thereby further improving the image searching accuracy.

In a possible implementation, the method further includes: deleting the category center features of the plurality of fourth categories from the feature library, and deleting the plurality of fourth categories from the plurality of reference image categories.

That is to say, the category center features of the plurality of fourth categories that are re-clustered into the fifth category are deleted from the feature library, and the plurality of fourth categories are deleted from the plurality of reference image categories. In this way, the category center features that do not exist in the feature library and the image categories that do not exist in the plurality of reference image categories may be deleted in time, so that the image searching efficiency may be increased.

FIG. 2 illustrates a schematic diagram of an application scenario of the image processing method according to an embodiment of the present disclosure. As shown in FIG. 2, for a to-be-processed image 21, the feature extraction may be performed firstly to obtain its first feature 22. Then, according to the first feature 21 and category center features 23 of a plurality of reference image categories in the feature library, an image category 24 of the to-be-processed image may be determined by algorithms in a similarity search library 29 (i.e., Faiss). When the image category 24 of the to-be-processed image 21 is a first category 26 among the plurality of reference image categories, the category center feature of the first category 26 may be updated according to the first feature 21 and a plurality of pieces of feature information of the first category 26 in the feature library. When the image category 24 of the to-be-processed image 21 is no category 25, clustering 27 can be performed on the to-be-processed image 21 through the algorithm in the similarity search library 29 (i.e., Faiss). The new image category 28 may be determined according to a clustering result. The first feature and the category center feature of the new image category 28 are added to the feature library. The new image category 28 is added to the plurality of reference image categories.

The image processing method of the embodiment of the present disclosure may determine the image category of the to-be-processed image according to the feature information of the image and the category center features in the feature library and update the feature library and the image category so as to realize the clustering of the to-be-processed image, which not only may increase the image searching, especially the face searching speed and the recall rate, but also may establish automatically personal files, thereby improving the image utilization rate.

Prior to the image searching, the to-be-processed image is clustered, so that the image searching, especially the face searching speed and the recall rate may be increased. For example, the face searching is an important scene for tracking down a criminal in public security industry. The searching is performed in the massive image database according to the picture of an unidentified suspect to determine a series of information of the suspect such as the identity. Prior to the searching, the image processing may be performed on the picture of the suspect to determine the image category (clustering); and during the searching, by comparing the picture of the suspect and the category center feature, the searching speed and the recall rate may be increased, so that more accurate information of the suspect may be returned more quickly, thereby helping the working personnel of the public security to study and judge more quickly the information of the suspect and crack a criminal case.

The image processing method according to the embodiment of the present disclosure may implement the clustering on the to-be-processed image and may establish automatically the personal file, so that the image utilization rate may be increased. For example, in a public security information system, there are massive snapped pictures. After the image processing is performed on these snapped pictures, the snapped pictures may be clustered into one category by an artificial dimension, so that the integration of massive and scattered pictures may be realized, all snapped pictures related to the same person may be seen in the system, and a personal trajectory is formed to realize the big data analysis, thereby assisting the case study.

The image processing method according to the embodiment of the present disclosure may implement the automatic iteration of the image system by clustering, and may update the image categories and category centers thereof every time the new to-be-processed images are clustered, so that the system gets incremental training continuously to form positive feedback cycling, thereby improving the system capacity.

It may be understood that the above method embodiments described in the present disclosure may be combined with each other to form combined embodiments without departing from principles and logics, which are not repeated in the present disclosure due to space limitation.

Furthermore, the present disclosure further provides an image processing apparatus, an electronic device, a computer-readable storage medium and a program, all of which may be used to implement any image processing method provided by the present disclosure. For the corresponding technical solutions and descriptions, please refer to the corresponding records in the method section, which will not be repeated.

It will be appreciated by those skilled in the art that in the above method of the specific implementation, the order of each step does not mean a strict execution order to constitute any limitation to the implementation process, and the specific execution order of each step should be determined by the functions and possible internal logics.

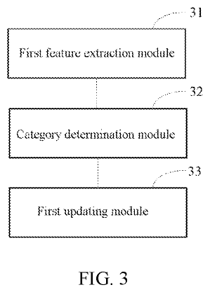

FIG. 3 illustrates a block diagram of an image processing apparatus according to an embodiment of the present disclosure. As shown in FIG. 3, the image processing apparatus includes:

A first feature extraction module 31, configured to perform feature extraction on a to-be-processed image to obtain a first feature of the to-be-processed image;

A category determination module 32, configured to determine an image category of the to-be-processed image according to the first feature and category center features of a plurality of reference image categories in a feature library; and

A first updating module 33, configured to, in response to the image category of the to-be-processed image being a first category among the plurality of reference image categories, update the category center feature of the first category according to the first feature and a plurality of pieces of feature information of the first category in the feature library.

In a possible implementation, the apparatus further includes: a second feature extraction module configured to, in response to the image category of the to-be-processed image being not any category of the plurality of reference image categories, perform category center extraction on the first feature of the to-be-processed image to obtain a category center feature of a second category of the to-be-processed image; and a second updating module configured to add the category center feature of the second category and the first feature to the feature library, and to add the second category to the plurality of reference image categories.

In a possible implementation, the apparatus further includes: a first clustering module, configured to, in response to the image category of the to-be-processed image being not any category of the plurality of reference image categories, perform clustering on the first feature of the to-be-processed image to obtain one or more third categories; a third feature extraction module, configured to perform category center extraction on the one or more third categories to obtain a category center feature of the one or more third category; and a third updating module, configured to add the category center features of the one or more third category and the first feature to the feature library, and to add the one or more third category to the plurality of reference image categories.

In a possible implementation, the category determination module 32 includes: a distance determination submodule, configured to acquire a plurality of first distances between the first feature and each of a plurality of category center features; and a first category determination submodule, configured to, in response to a second distance as a minimum distance value among the plurality of first distances being less than or equal to a distance threshold, determine the image category of the to-be-processed image as the first category corresponding to the second distance.

In a possible implementation, the category determination module 32 includes: a second category determination submodule, configured to, in response to the second distance being greater than the distance threshold, determine the image category of the to-be-processed image to be not any category of the plurality of reference image categories.

In a possible implementation, the category center features include N category center features, where N is a positive integer. The distance determination submodule is configured to perform quantification on the N category center features respectively to obtain N feature vectors; to acquire N third distances between the first feature and the N feature vectors respectively; to determine K category center features corresponding to K smallest approximate distances among the N third distances; and to determine K first distances between the first feature and the K category center features, where K is a positive integer, and K<N.

In a possible implementation, the apparatus further includes: a fourth feature extraction module, configured to perform category center extraction on the feature information of each of the plurality of reference image categories in the feature library respectively to obtain a category center feature of the respective reference image category.

In a possible implementation, the first feature extracting module 31 includes: a feature extraction submodule, configured to perform feature extraction on the to-be-processed image to obtain a second feature of the to-be-processed image; and a normalization submodule, configured to normalize the second feature to obtain the first feature of the to-be-processed image.

In a possible implementation, the apparatus further includes: a second clustering module, configured to, in response to a plurality of fourth categories in the feature library corresponding to a same object, perform re-clustering on the feature information of the plurality of fourth categories to obtain a fifth category; a fifth feature extraction module, configured to perform category center extraction on the fifth category to obtain a category center feature of the fifth category; and a fourth updating module, configured to add the category center feature of the fifth category to the feature library, and to add the fifth category to the plurality of reference image categories.

In a possible implementation, the apparatus further includes: a deletion module, configured to delete the category center features of the plurality of fourth categories from the feature library, and to delete the plurality of fourth categories from the plurality of reference image categories.

In some embodiments, functions or modules of the apparatus provided in the embodiments of the present disclosure may be used to execute the method described in the above method embodiments, which may be specifically implemented by referring to the above descriptions of the method embodiments, and are not repeated here for brevity.

An embodiment of the present disclosure further provides a computer readable storage medium having computer program instructions stored thereon, wherein the computer program instructions, when executed by a processor, implement the above method. The computer readable storage medium may be a non-volatile computer readable storage medium or volatile computer readable storage medium.

An embodiment of the present disclosure further provides an electronic device, which includes a processor and a memory configured to store processor executable instructions, wherein the processor is configured to execute the above method.

An embodiment of the present disclosure further provides a computer program product, which includes computer readable codes. When the computer readable codes are run on the electronic device, the processor in the electronic device executes the instructions for implementing the image processing method as provided in any of the above embodiments.

The electronic device may be provided as a terminal, a server or a device in any other form.

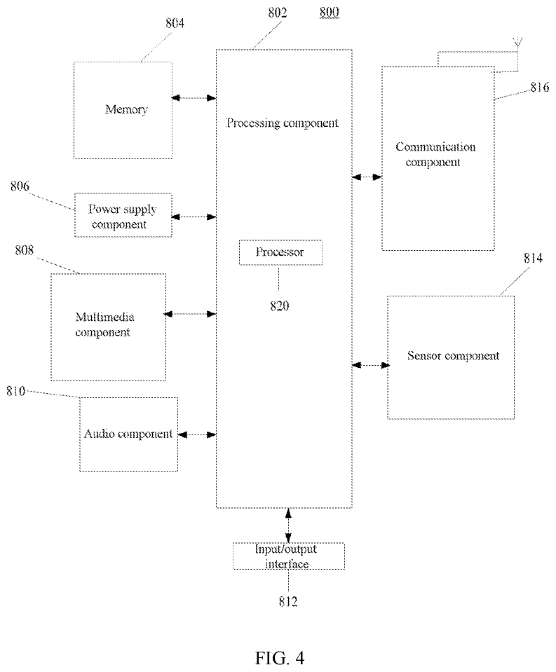

FIG. 4 illustrates a block diagram of an electronic device 800 according to an embodiment of the present disclosure. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 4, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operation of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage devices or a combination thereof, such as static random access memory (SRAM), electronic erasable programmable read-only memory (EEPROM), erasable programmable read-only memory (EPROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to the power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice recognition mode, the microphone is configured to receive an external audio signal. The received audio signal may be further stored in the memory 804 or transmitted via the communication component 816. In some embodiments, the audio component 810 further includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to a home button, a volume button, a start button and a lock button.

The sensor component 814 includes one or more sensors which are configured to provide state evaluation in various aspects for the electronic device 800. For example, the sensor component 814 may detect an on/off state of the electronic device 800 and relative positions of the components such as a display and a small keyboard of the electronic device 800. The sensor component 814 may also detect the position change of the electronic device 800 or a component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a CMOS or CCD image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wired or wireless manner between the electronic device 800 and other devices. The electronic device 800 may access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to facilitate short range communication. For example, the NFC module may be implemented on the basis of radio frequency identification (RFID) technology, infrared data association (IrDA) technology, ultrawide band (UWB) technology, Bluetooth (BT) technology and other technologies.

In exemplary embodiments, the electronic device 800 may be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of the electronic device 800 to implement the above method.

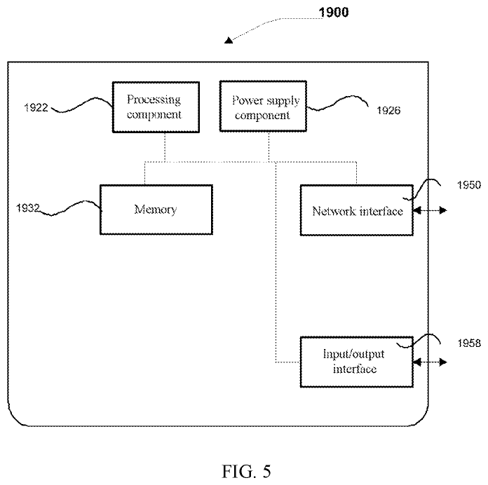

FIG. 5 illustrates a block diagram of an electronic device 1900 according to an embodiment of the present disclosure. For example, the electronic device 1900 may be provided as a server. Referring to FIG. 5, the electronic device 1900 includes a processing component 1922, and further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wired or wireless network interface 1950 configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™ or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium may be a tangible device that may retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein may be downloaded to individual computing/processing devices from a computer readable storage medium or to an external computer or external storage device via network, for example, the Internet, local region network, wide region network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local region network (LAN) or wide region network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, may be implemented by the computer readable program instructions.

These computer readable program instructions may be provided to a processor of a general purpose computer, a dedicated computer, or other programmable data processing devices, to produce a machine, such that the instructions create means for implementing the functions/acts specified in one or more blocks in the flowchart and/or block diagram when executed by the processor of the computer or other programmable data processing devices. These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, may be implemented by dedicated hardware-based systems performing the specified functions or acts, or by combinations of dedicated hardware and computer instructions.

On the premise of not violating the logic, different embodiments of the present disclosure may be combined with one another. Different embodiments may describe different aspects. For the emphasized description, please refer to the records of other embodiments.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image processing method, comprising:
performing feature extraction on a to-be-processed image to obtain a first feature of the to-be-processed image;
determining an image category of the to-be-processed image according to the first feature and a plurality of category center features of a plurality of reference image categories in a feature library; and
in response to the image category of the to-be-processed image being a first category among the plurality of reference image categories, updating the category center feature of the first category according to the first feature and a plurality of pieces of feature information of the first category in the feature library.

2. The method according to claim 1, wherein the method further comprises:
in response to the image category of the to-be-processed image being not any category of the plurality of reference image categories, performing category center extraction on the first feature of the to-be-processed image to obtain a category center feature of a second category of the to-be-processed image; and
adding the category center feature of the second category and the first feature to the feature library, and adding the second category to the plurality of reference image categories.

3. The method according to claim 1, wherein the method further comprises:
in response to the image category of the to-be-processed image being not any category of the plurality of reference image categories, performing clustering on the first feature of the to-be-processed image to obtain one or more third categories;
performing category center extraction on the one or more third categories to obtain a category center feature of the one or more third category; and
adding the category center feature of the one or more third categories and the first feature to the feature library, and adding the one or more third categories to the plurality of reference image categories.

4. The method according to claim 1, wherein determining the image category of the to-be-processed image according to the first feature and the plurality of category center features of the plurality of reference image categories in the feature library comprises:
acquiring a plurality of first distances between the first feature and each of the plurality of category center features; and
in response to a second distance as a minimum distance value among the plurality of first distances being less than or equal to a distance threshold, determining the image category of the to-be-processed image as the first category corresponding to the second distance.

5. The method according to claim 4, wherein determining the image category of the to-be-processed image according to the first feature and the plurality of category center features of the plurality of reference image categories in the feature library comprises:
in response to the second distance being greater than the distance threshold, determining the image category of the to-be-processed image to be not any category of the plurality of reference image categories.

6. The method according to claim 4, wherein the category center features include N category center features, where N is a positive integer; and acquiring the plurality of first distances between the first feature and each of the plurality of category center features comprises:
performing quantification on the N category center features respectively to obtain N feature vectors;
acquiring N third distances between the first feature and the N feature vectors respectively;
determining K category center features corresponding to K smallest approximate distances among the N third distances; and
determining K first distances between the first feature and the K category center features, where K is a positive integer, and K<N.

7. The method according to claim 1, wherein the method further comprises:
performing category center extraction on the feature information of each of the plurality of reference image categories in the feature library respectively to obtain the category center feature of the reference image category.

8. The method according to claim 1, wherein performing feature extraction on the to-be-processed image to obtain the first feature of the image comprises:
performing feature extraction on the to-be-processed image to obtain a second feature of the to-be-processed image; and
normalizing the second feature to obtain the first feature of the to-be-processed image.

9. The method according to claim 1, wherein the method further comprises:
in response to a plurality of fourth categories in the feature library corresponding to a same object, performing re-clustering on the feature information of the plurality of fourth categories to obtain a fifth category;
performing category center extraction on the fifth category to obtain a category center feature of the fifth category; and
adding the category center feature of the fifth category to the feature library, and adding the fifth category to the plurality of reference image categories.

10. The method according to claim 9, wherein the method further comprises:
deleting the category center features of the plurality of fourth categories from the feature library, and deleting the plurality of fourth categories from the plurality of reference image categories.

11. An image processing device, comprising:
a processor; and
a memory configured to store processor executable instructions,
wherein the processor is configured to execute instructions stored by the memory, so as to:
perform feature extraction on a to-be-processed image to obtain a first feature of the to-be-processed image;
determining an image category of the to-be-processed image according to the first feature and a plurality of category center features of a plurality of reference image categories in a feature library; and
in response to the image category of the to-be-processed image being a first category among the plurality of reference image categories, update the category center feature of the first category according to the first feature and a plurality of pieces of feature information of the first category in the feature library.

12. The image processing device according to claim 11, wherein the processor is further configured to:
in response to the image category of the to-be-processed image being not any category of the plurality of reference image categories, perform category center extraction on the first feature of the to-be-processed image to obtain a category center feature of a second category of the to-be-processed image; and
add the category center feature of the second category and the first feature to the feature library, and adding the second category to the plurality of reference image categories.

13. The image processing device according to claim 11, wherein the processor is further configured to:
in response to the image category of the to-be-processed image being not any category of the plurality of reference image categories, perform clustering on the first feature of the to-be-processed image to obtain one or more third categories;
perform category center extraction on the one or more third categories to obtain a category center feature of the one or more third category; and
add the category center feature of the one or more third categories and the first feature to the feature library, and add the one or more third categories to the plurality of reference image categories.

14. The image processing device according to claim 11, wherein determining the image category of the to-be-processed image according to the first feature and the plurality of category center features of the plurality of reference image categories in the feature library comprises:
acquiring a plurality of first distances between the first feature and each of the plurality of category center features; and
in response to a second distance as a minimum distance value among the plurality of first distances being less than or equal to a distance threshold, determining the image category of the to-be-processed image as the first category corresponding to the second distance.

15. The image processing device according to claim 14, wherein determining the image category of the to-be-processed image according to the first feature and the plurality of category center features of the plurality of reference image categories in the feature library comprises:
in response to the second distance being greater than the distance threshold, determining the image category of the to-be-processed image to be not any category of the plurality of reference image categories.

16. The image processing device according to claim 14, wherein the category center features include N category center features, where N is a positive integer; and acquiring the plurality of first distances between the first feature and the category center features comprises:
performing quantification on the N category center features respectively to obtain N feature vectors;
acquiring N third distances between the first feature and the N feature vectors respectively;
determining K category center features corresponding to K smallest approximate distances among the N third distances; and
determining K first distances between the first feature and the K category center features, where K is a positive integer, and K<N.

17. The image processing device according to claim 11, wherein the processor is further configured to:
perform category center extraction on the feature information of each of the plurality of reference image categories in the feature library respectively to obtain the category center feature of the reference image category.

18. The image processing device according to claim 11, wherein performing feature extraction on the to-be-processed image to obtain the first feature of the to-be-processed image comprises:
performing feature extraction on the to-be-processed image to obtain a second feature of the to-be-processed image; and
normalizing the second feature to obtain the first feature of the to-be-processed image.

19. The image processing device according to claim 11, wherein the processor is further configured to:
in response to a plurality of fourth categories in the feature library corresponding to a same object, perform re-clustering on the feature information of the plurality of fourth categories to obtain a fifth category;
perform category center extraction on the fifth category to obtain a category center feature of the fifth category; and
add the category center feature of the fifth category to the feature library, and add the fifth category to the plurality of reference image categories.

20. A non-transitory computer readable storage medium having computer program instructions stored thereon, wherein the computer program instructions, when executed by a processor, implement operations comprising:
performing feature extraction on a to-be-processed image to obtain a first feature of the image;
determining an image category of the to-be-processed image according to the first feature and category center features of a plurality of reference image categories in a feature library; and
in response to the image category of the to-be-processed image being a first category among the plurality of reference image categories, updating the category center feature of the first category according to the first feature and a plurality of pieces of feature information of the first category in the feature library.
